(19) United States
(12) Patent Application Publication
(10) Pub. No.: US 2006/0252891 A1
(43) Pub. Date: Nov. 9, 2006

(54) Epoxy-acrylate/amine adhesive composition

(75) Inventor: Peter J. McQuaid, York, PA (US)

Correspondence Address: H. JAY SPIEGEL - H. JAY SPIEGEL & ASSOCIATES, P.O. BOX 11, MOUNT VERNON, VA, 22121, US

(73) Assignee: AdLamCo, Inc.

(21) Appl. No.: 11/485,880

(22) Filed: Jul. 14, 2006

Related U.S. Application Data
(62) Division of application No. 10/378,935, filed on Mar. 5, 2003.

(51) Int. Cl. C08L 63/00

(52) U.S. Cl. 525/530

(57) ABSTRACT

A 100% solids laminating adhesive for flexible packaging with an improved range of adhesion and bond strength to various substrates along with reduced odor during application and improved ink compatibility and ink bonding. The adhesive is an epoxy-acrylate/amine formulation. Methods of application of the inventive adhesive are also disclosed.

### BACKGROUND OF THE INVENTION

Traditionally, when preparing some types of packaging intended to be used to package food products, film is printed on one side, adhesive is applied on top of the printing as well as on the clear areas surrounding the printing, and then the film is laminated to a second film at a laminating nip. In in-line printing, the adhesive is coated on top of the freshly printed ink or the opposite web and immediately thereafter is laminated.

On web machines having a width of 30 inches to 60 inches or more, coating is typically accomplished by employing rotogravure and flexo coating, although other techniques may be used. In many cases, lamination is accomplished “out of line,” meaning that a printed roll is taken to another location for lamination.

In early years of lamination of such packaging materials, solvent borne polyurethane adhesives were employed that gave good “green” tack and cured further to create good laminations. Over the last 20 years, water borne adhesives have replaced many of the solvent-based adhesives due to the reduction of emissions of noxious vapors (VOCs). Water borne adhesives include urethanes, acrylics and other hybrids. Of course, solvent-based adhesives are still employed as well.

As the industry has evolved, the desire to reduce solvent emissions created a demand for water based adhesives. However, a 100% solids polyurethane chemistry using a very expensive four or five roll coating head is currently making big inroads into the market for laminating adhesives. Such systems are prevalent in Europe and are gaining more acceptance in the United States. When the four or five roll coating head systems are used, no oven is employed for drying but most of the adhesives, if not all of them, must be kept hot or heated during application because the adhesives have high viscosities. As should be understood, heating the adhesives reduces the viscosity. However, at the same time, application of heat severely reduces the pot life of the material. In other words, application of heat initially reduces viscosity but speeds the initiation of the exothermic reaction that results in adhesive curing and rapid viscosity increase. The pot life of an adhesive is the time period from the moment it is mixed until the moment the exothermic curing reaction begins to make it unusable. When reaction begins, viscosity rapidly increases.

The adhesives employed with the four or five roll coating system are typically two component polyurethane/isocyanate systems that must be mixed. Such adhesives are adversely affected by moisture in the air and their higher viscosity, in the range of 1000 cps or more, requires use of the four or five roll coating system.

In the normal use of 100% solids urethane adhesives, there is a major health issue that has surfaced in which the urethanes may pose a health hazard when used in laminating film for flexible packaging used for foodstuffs. In essence, the isocyanate in the adhesive reacts with water or moisture forming aromatic diamine which is a suspected health hazard and can also migrate through the film.

For some converters using the four or five roll system, the polyurethane adhesives are heated as high as 150 to 160° F. in order to obtain a runnable viscosity. When such heating is done and the film is run at a speed of over 500 feet per minute, misting can occur which fouls many of the parts of the machinery, and contaminates the atmosphere around the machine thereby creating a potential health hazard for the operator of the machine. To prevent this problem, often, the machinery must be slowed down to prevent misting. Although, four and five roll coating systems can run adhesives having a viscosity of 1,000 cps or higher, the misting issue must be addressed in order to effectively coat film while avoiding expensive machinery up keep and danger to the health of the machine operator.

Often, products are sold using a “just in time” inventory storage procedure and, due to this procedure, demand is increasing for packaging that may be printed and laminated on narrow web presses such as those having a width of 26 inches or less. One example of such an application is the creation of bottle labels of film-to-film laminations. Flexographic presses are often used to print images on the film. In such systems, in order to make the presses capable of laminating, a system was devised to use an ultraviolet cured adhesive having a low enough viscosity to allow coating by flexographic presses with curing being accomplished immediately thereafter using an ultraviolet light source. Ultraviolet curing has a severe limitation - it cannot be used to cure adhesive on a metallized web combined with a reverse printed web because the ultraviolet light will not penetrate the ink or metal. The same is true where the film is white or opaque.

As is well known in the art, water or solvent based adhesives are not typically used on flexographic presses because it is quite difficult to apply a sufficient amount of adhesive in a flexographic press and such adhesives are difficult to dry. With typical printing, it has been found that the only way to use water or solvent-based adhesives in a flexographic press is to slow the speed of production or equip the production line with a much larger drying oven. Limitations on production speed are problematic. Thus, the ultraviolet curing system is a preferred system for use with narrow width presses with the UV cured adhesive having a viscosity of about 400 cps. Such a system works adequately for ultraviolet bottle label applications but has been found to be unacceptable for applications where one of the films comes in contact with a food product. It has been found that the ultraviolet photo initiators do not fully respond to the ultraviolet light and, as such, the U.S. Food and Drug Administration has not accepted such adhesives for use in indirect food packaging.

Manufacturers of solvent borne adhesives have attempted to make very high solids (65%) adhesives that can be coated on a gravure press. Such an application reduces the emissions but has not been commercially successful. Water based adhesives comprising up to 60% solids have been developed with such configuration helping in drying and coating weight but only limited applications have been found for such adhesives.

U.S. Pat. No. 4,216,252 to Moeller discloses a solventless release coating. While the solventless nature of the release coating is analogous to the adhesive employed in the present invention, the particular coating employed is significantly different from the adhesive employed herein, and is used for a different purpose.

In the present invention, not only can the 100% solids adhesive be coated by the gravure process as disclosed in U.S. Pat. Nos. 6,464,813 B 1 and 6,491,783 B 2, but this can be done in a typical wet laminating configuration. Such a system uses a third roll in contact with the impression roll to act as the laminating nip eliminating the need for a separate laminating station. Wet laminating is normally done with a paper or porous substrate that allows the water or solvent from the adhesive to be released in the subsequent oven prior to winding the finished roll of laminated webs. Since this invention is 100% solids adhesive, non porous webs such as films and foil can be laminated with no oven required. Consequently the coating and laminating are done in a single station rather than separate coating and laminating stations. The single station coating and laminating station eliminates the need for providing web tension control between the stations as well as lower cost and more compact machine design.

The development and use of low viscosity 100% solids laminating adhesive for flexible packaging is of recent development and use. Applicant notes that U.S. Pat. No. 6,464,813 B 1 discloses a laminating and coating system for a gravure or flexographic set up employing an enclosed doctor blade with recirculation to coat adhesive onto a film and then laminating it to another film. U.S. Pat No. 6,464,813 B1 further describes the adhesive as a 100%, solventless adhesive having zero VOC, a viscosity of from 300-400 cps at a temperature of from 50-80° F., a pot life of up to 3 hours at 50-80° F. that is unaffected by moisture and is usable in laminating films to be used as food product packaging. The preferred adhesive is described as a 2 part epoxy adhesive in which 2 parts of part A is mixed with about 1 part of part B where part A is 34%, by weight, Bisphenol A Type Epoxy Resin, 51%, by weight, Aliphatic DIEPOXIDE Epoxy Resin, 1%, by weight, Nonionic defoamer, 13%, by weight, Dipropylene Glycol Dibenzoate, 1%, by weight, Silicone Free Surfactant; and part B is 79%, by weight, Amidoamine Curing Agent, 20%, by weight, Aliphatic Amidoamine Curing Agent, 0.5%, by weight, Nonionic defoamer and 0.5%, by weight, Silicone Free Surfactant. Although the epoxy formulation described does function well as a film laminating adhesive it does have shortcomings with regard to the presence of a strong pungent odor during application, low bond strength to certain substrates, and bleed or compatibility issues with certain type inks used to print on films.

U.S. Pat. No. 6,491,783 B2 also describes a laminating and coating system for a gravure or flexographic set up employing an enclosed doctor blade with recirculation to coat adhesive onto a film and then laminating it to another film. U.S. Pat. No. 6,491,783 B2 also describes the adhesive as a 100%, solventless adhesive having 0 VOC, a viscosity of from 300-1500 cps at a temperature of from 50-80° F., a pot life of up to 3 hours at 50-80° F. that is unaffected by moisture and is usable in laminating films to be used as food product packaging. A further embodiment is an adhesive having an operating temperature viscosity of 200 to 1500 cps and made up of Part A and Part B mixed together wherein Part A consists of a mixture including Bisphenol A or F type epoxy resin; Part B including Amine Curing Agent; said adhesive being 100% solids and composed of constituent ingredients substantially precluding said adhesive from imparting odors to food products packaged in films laminated with said adhesive, said adhesive having a pot life of up to 3 hours at 50 to 80° F. The specific epoxy adhesives mentioned in U.S. Pat. Nos. 6,464,813 B 1 and 6,491,783 B2 function well but give low adhesion to certain substrates such as metallized film. They also have pungent odor issues during application and in many instances cause ink running or bleeding with certain types of ink.

The variety of compositions of inks commonly used in flexible packaging is infinite. There are primary base materials used such as polyurethane, acrylic, nitrocellulose, polyester, vinyl etc. The pigment systems vary widely as well depending on the requirements. For example, the systems for automotive application require high solvent resistance but are the most expensive. The pigments themselves vary depending again on the application and color strength. On top of that add the processing requirements and special requirements for a specific customer or process and there is no real telling what is in an ink. Consequently, there is no way to have a standard to test against. This is one of the maddening parts of the laminating printing and coating business. A converter is afraid to change inks not knowing what will happen and by the same token they are afraid to change adhesives for fear there may be an adverse consequence with the ink in some cases. Many times the adhesive employed in the lamination process causes ink running or bleeding, delamination or decaling, or poor bond strength to the ink let alone to the film. The adhesive must bond to the ink as well as to the film without causing the ink to bleed, run, delaminate, decal or generate poor bond strength. Thus, a need has developed for an adhesive that is effective regardless of the composition of the ink.

The films used in film lamination for food packaging are of an infinite variety since there are different film types, applications and manufacturers. For example, polyethylene can be high density, low density, linear low density, metallocene and can have various amounts of ethylene vinyl acetate (EVA) for better sealing properties. In addition, some polyethylenes are made to have high oxygen transmission. It is truly as complicated as the inks when the surface properties are considered as well as cast, blown or oriented in one or two directions. As a result, the adhesive employed must be universal in nature or chosen based upon the substrate film and/or ink that is being used for the particular film laminate application. Adhesives currently marketed today unfortunately are not universal in that many are suited only for a particular type film substrate. This presents significant difficulty to the applicator in that he may be restricted to certain films because of the adhesive employed. Thus, a need has developed for an adhesive that is effective regardless of the composition of the film.

Each of the techniques and adhesives described above presents significant limitations of one kind or another, whether it be noxious emissions, including misting, requirement for quick production, difficulties in uniform curing, heating requirements coupled with short pot lives, etc. Additionally, some adhesives can cause smudging or bleeding of some inks used to print of the films to be laminated which can cause poor print quality on the finished packaging. As such, a need has developed for an improved coating or laminating adhesive to be used as described in U.S. Pat. Nos. 6,464,813 B 1 and 6,491,783 B2 having a sufficiently low enough viscosity at room temperature to permit even and predictable flow, wherein the adhesive does not emit noxious fumes, is not affected by moisture, where pot life is extended to a sufficient degree to increase efficiency of production, and wherein the adhesive employed in the process is deemed acceptable by the U.S. Food and Drug Administration for use in laminating packaging to be used to package food products, and wherein smudging or bleeding of the inks may be reduced.

The adhesive compositions of the present invention improve on the bond strength of a wider variety of substrates, have compatibility with a wider range of ink systems used to print on films used in the flexible packaging industry with regard to ink bleed and subsequent color distortion as well as the bond strength of the laminations. They also provide for a low odor application environment. A further advantage of the present invention is to provide an adhesive that has rapid gelation, thus preventing penetration into the ink. No matter which of the adhesive formulations of this invention are employed, a more universal strong bond to ink is obtained.

### SUMMARY Of THE INVENTION

The present invention provides an improved film lamination adhesive for use in a laminating and coating system with a gravure or flexographic set up using an enclosed doctor blade system with recirculation to coat adhesive onto a film and then laminate it to another film as described in U.S. Pat. Nos. 6,464,813 B 1 and 6,491,783 B2. In addition, the adhesive can be coated using a typical wet laminating station to coat and laminate with no drying required. The improved film laminating adhesive of this invention meets all the criteria for a film laminating adhesive as described in U.S. Pat. Nos. 6,464,813 B 1 and 6,491,783 B2 consisting of a zero VOC 100% solids laminating adhesive having a viscosity range of 200-1500 cps which remains within a desired range of 50-100° F. for up to 3 hours that will cure at ambient temperature. The improved adhesive of this invention is solventless and is unaffected by moisture. The adhesive of this invention also has a sufficiently low enough viscosity at room temperature to permit even and predictable flow, wherein the adhesive does not emit noxious fumes, is not affected by moisture, where pot life is extended to a sufficient degree to increase efficiency of production, and wherein the adhesive employed in the process is deemed acceptable by the U.S. Food and Drug Administration for use in laminating packaging to be used to package food products, and wherein smudging or bleeding of the inks is reduced eliminating poor print quality on the finished packaging, and improved ink bond strength. The adhesive consists of a 2 part formulation including an epoxy-acrylate/amine formulation.

### DETAILED DESCRIPTION OF THE INVENTION

The adhesive of this invention is in effect a 2 part adhesive formulation comprised of part A and part B, wherein part A is a liquid epoxy and acrylate/methacrylate mixture and part B is a polyamine curative containing primarily a polyoxyalkylenepolyamine. Other additives, fillers, reactive and non-reactive additives may also be added to the adhesive formulation of this invention without compromising the uniqueness or spirit of this invention. The adhesive is zero VOC and 100% solids. It has a viscosity range of 200-1500 cps within a desired range of 50-100° F. for up to 3 hours and will cure at ambient room temperature. The improved adhesive of this invention is solventless and is unaffected by moisture. The adhesive of this invention also has a sufficiently low enough viscosity at room temperature to permit even and predictable flow, wherein the adhesive does not emit noxious fumes, is not affected by moisture, where pot life is extended to a sufficient degree to increase efficiency of production, and wherein the adhesive employed in the process is deemed acceptable by the U.S. Food and Drug Administration for use in laminating packaging to be used to package food products, and wherein smudging or bleeding of the inks is reduced eliminating poor print quality on the finished packaging, and improved ink bond strength.

The ratio of part A to part B of the 2 part adhesive of this invention is dependent on the number of epoxy, acrylate and methacrylate reactive sites in part A and the number of amine hydrogens available for reaction in part B. The molar ratio of reactive sites in part A to part B may range from as much as 3:1 to 1:3 depending on the desired strength of the formulated adhesive and the cure time requirements. It is more desirable to have the number of reactive sites or stoichiometry closer to 1:1 so as to minimize the excess of either components and generate a more completely reactive formulation. The optimum stoichiometry for practical purposes is from 1.1:1.0 to 1.0:1.25.

Any combination of epoxy, acrylate and methacrylate are acceptable for part A so long as the resultant composition has a viscosity of from 50 to 2000 cps@ 25° C., is zero VOC, is odor free and is deemed acceptable by the U.S. Food and Drug Administration for use in laminating packaging to be used to package food products. Although any combination of epoxy, acrylate and methacrylate is acceptable, it is desirable to use a combination of epoxy and acrylate. The combination may range from 5 parts to 95 parts epoxy and 95 parts to 5 parts acrylate or methacrylate. The preferred ratio of epoxy to acrylate or methacrylate is from 0.6 to 2.0 parts of epoxy to 1.0 part of acrylate or methacrylate. The optimum being 1.0 part of epoxy and 1.0 part of acrylate or methacrylate.

The epoxy portion of part A may be comprised of any number of epoxy containing materials having from 1 to 5 epoxy groups per molecule so long as the final adhesive formulation has a viscosity of from 50 to 2000 cps@ 25° C. Polyglycidyl ethers based on Bis A and B is F resins are acceptable for use in part A. Aliphatic, cyclo-aliphatic, and aromatic mono and polyglycidyl ethers are also suitable for use in part A including, but not limited to, butyl, 2-ethylhexyl, C₈—C₁₀, C₁₂—C₁₄, butanediol, neopentyl glycol, cyclohexane dimethanol, phenyl, o-cresol, propylene glycol, tripropylene glycol, polypropylene glycol, trimethylol propane, etc. glycidyl ethers. Any glycidyl ether combination is acceptable so long as the final part A component has a viscosity of from 50 to 2000 cps@ 25° C., is zero VOC, is odor free and is deemed acceptable by the U.S. Food and Drug Administration for use in laminating packaging to be used to package food products. The preferred epoxy portion for part A of the adhesive formulation is liquid Bis A epoxy resin sold under the trade names Epon 828® and DER 331®.

The acrylate and/or methacrylate portion of part A may be comprised of any number of acrylate and/or methacrylate containing materials having from 1 to 5 acrylate and/or methacrylate groups per molecule so long as the final part A of the adhesive formulation has a viscosity of from 50 to 4000 cps@ 25° C., is zero VOC, and is deemed acceptable by the U.S. Food and Drug Administration for use in laminating packaging to be used to package food products. Polyacrylate and polymethacrylate esters or any combination thereof are well suited for this application. Acrylates that are particularly suited for this application are trimethylolpropane triacrylate (TMPTA), trimethylolethane triacrylate (TMETA), tripropylene glycol diacrylate, dipropylene glycol diacrylate, alkoxylated trimethylolpropane triacrylate, butanediol diacrylate, cyclohexanedimethanol diacrylate, polyethylene glycol diacrylate, polypropylene glycol diacrylate, alkoxylated bisphenol A diacrylate, alkoxylated hexanediol diacrylate, alkoxylated cyclohexanedimethanol diacrylate, alkoxylated neopentyl glycol diacrylate, neopentyl glycol diacrylate, octyldecyl acrylate, methoxy polyethylene glycol (350) monoacrylate, alkoxylated tetrahydrofurfuryl acrylate, alkoxylated lauryl acrylate, alkoxylated phenol acrylate, stearyl acrylate, tetrahydrofurfuryl acrylate, lauryl acrylate, 2-phenoxyethyl acrylate, isodecyl acrylate, isooctyl acrylate, caprolactone acrylate, isobornyl acrylate, alkoxylated nonyl phenol acrylate, 1,3 butylene glycol diacrylate, diethylene glycol diacrylate, tetraethylene glycol diacrylate, triethylene glycol diacrylate, alkoxylated aliphatic diacrylate, pentaerythritol triacrylate, ethoxylated trimethylolpropane triacrylate, propoxylated3 trimethylolpropane triacrylate, pentaerythritol tetraacrylate, ditrimethylolpropane tetraacrylate, dipentaerythritol pentaacrylate, pentaacrylate ester. Methacrylates that are particularly suited for this application are trimethylolpropane trimethacrylate (TMPTMA), trimethylolethane trimethacrylate (TMETMA), tripropylene glycol trimethacrylate, alkoxylated trimethylolpropane trimethacrylate, butanediol dimethacrylate, cyclohexanedimethanol dimethacrylate, polyethylene glycol dimethacrylate, polypropylene glycol dimethacrylate, alkoxylated bisphenol A dimethacrylate, alkoxylated hexanediol dimethacrylate, alkoxylated cyclohexanedimethanol dimethacrylate, alkoxylated neopentyl glycol dimethacrylate, neopentyl glycol dimethacrylate, octyldecyl methacrylate, methoxy polyethylene glycol (350) monomethacrylate, alkoxylated tetrahydrofurfuryl methacrylate, alkoxylated lauryl methacrylate, alkoxylated phenol methacrylate, stearyl methacrylate, tetrahydrofurfuryl methacrylate, lauryl methacrylate, 2-phenoxyethyl methacrylate, isodecyl methacrylate, isooctyl methacrylate, caprolactone methacrylate, isobomyl methacrylate, alkoxylated nonyl phenol methacrylate, 1,3 butylene glycol dimethacrylate, diethylene glycol dimethacrylate, tetraethylene glycol dimethacrylate, triethylene glycol dimethacrylate, alkoxylated aliphatic dimethacrylate, pentaerythritol trimethacrylate, ethoxylated3 trimethylolpropane trimethacrylate, propoxylated3 trimethylolpropane trimethacrylate, pentaerythritol tetramethacrylate, di-trimethylolpropane tetramethacrylate, dipentaerythritol pentamethacrylate, pentamethacrylate ester. The optimum polyacrylate/methacrylate ester for use in part A is trimethylolpropane triacrylate or a blend of trimethylolpropane triacrylate and tripropylene glycol diacrylate. The ideal blend being 1 part trimethylolpropane triacrylate to 1 part tripropylene glycol diacrylate.

Part B of the adhesive formulation of this invention may be comprised of any amine curative or mixtures thereof so long as the adhesive formulation has a viscosity of from 10 to 2000 cps@ 25° C., is zero VOC, is odor free and is deemed acceptable by the U.S. Food and Drug Administration for use in laminating packaging to be used to package food products. Polyoxyalkylene polyamines, blends of polyoxyalkylene polyamines, adducts of polyoxyalkylene polyamines, and combinations thereof, as well as mixtures with other amine curatives have been found to be superior for this application. The polyoxyalkylene polyamines most suitable for use in part B of this adhesive are polyoxypropylenediamines, polyoxypropylenetriamines, bis-(1-aminopropoxy)-diethylether, bis-(1-aminopropoxy)-ethoxydiethyl ether and bis-(1-aminopropoxy)polyethylene glycol. Adducts of these polyoxyalkylene polyamines obtained from a reaction with glycidyl ethers such as butyl, 2-ethylhexyl, C₈—C₁₀, C₁₂—C₁₄, butanediol, neopentyl glycol, cyclohexane dimethanol, phenyl, o-cresol, propylene glycol, tripropylene glycol, polypropylene glycol, trimethylol propane, etc. glycidyl ethers are also suitable. Adducts generated from reaction with Bis A and Bis F epoxy resins are equally suitable. The ideal part B formulation for use in this invention is polyoxypropylene diamine, commercially available under the trade name of Jeffamine D-230®, or an adduct prepared from the reaction of said amine with the diglycidyl ether of Bis phenol A commercially available under trade names such as Epon 828® or DER 331®. The optimum part B of this invention is a polyamine mixture of polyoxypropylenediamine (D-230) and the adduct formed from the reaction of polyoxypropylenediamine (D-230) and the diglycidyl ether of Bis phenol A (Epon 828® or DER 331®) such that the ratio of polyoxypropylenediamine (D-230) to the diglycidyl ether of Bis phenol A (Epon 828® or DER 331® is 80 parts to 20 parts by weight.

The improved adhesive herein described is applied in accordance with the procedures found in U.S. Pat. Nos. 6,464,813 B 1 and 6,491,783 B2. A laminating or coating system is employed with a gravure or flexographic set up using an enclosed doctor blade system with recirculation to coat adhesive onto a film and then laminate it to another film. The system described is a 2 doctor blade coating system. Two doctor blades combine with other structure to form an enclosed chamber, which receives adhesive. The adhesive is pumped into the chamber and, within the chamber, engages a portion of the circumference of a roll having a surface texture. While this may be described as knurled, it is more accurately called an anilox roll or gravure cylinder. It may be engraved or ceramic coated with one of several patterns laser etched into the surface. The chamber has an exit allowing adhesive to be recirculated during the conduction of the process. A circulating pump is employed that pumps adhesive from a sump to the enclosed chamber and the sump receives adhesive recirculated back from the enclose chamber. Adhesive is mixed and supplied to the sump while the process is being conducted so that the enclosed chamber is continuously full of adhesive. Neither the blades nor the nip are heated and the process is conducted at room temperature. The blades may be cooled to offset the heat generated by frictional interaction between the blades and knurled roll to maintain the adhesive at the desired temperature. In order to make sure that the chamber defined by the doctor blades is always full of adhesive; the recirculating pump is designed to pump adhesive at a flow rate twice that of the rate of adhesive usage by the system. The advantage herein described is the ability to coat 100% solids adhesive by gravure coating technique. Such a technique may be performed both in-line, usually by applying the adhesive to an unprinted web with its own oven, as well as out-of-line on a separate machine. Using the 100% solids adhesive described, coating and laminating can be done in a single station. Since the need for a drying tunnel is eliminated, the lamination can be accomplished on the impression roll of the gravure station. This technique is known by those skilled in the art and referred to as wet bond laminating. In normal wet bond laminating however the combined webs travel through a drying tunnel to remove the solvent or water used in the laminating adhesive. In this case, since no drying is required, the webs can be wound immediately after lamination with no tunnel, since no heat or drying are required in the process. This makes for a very compact laminator and eliminates the requirement to tension control webs between the coating and laminating stations as well as eliminating the cost of a separate laminating station. Such a technique can also be accomplished in the last deck of a flexopress as would be done on a narrow machine. The wide web application is extremely important since the wider web increases the amount of surface area per unit time flows through the machine. Thus, the wider web consumes a much higher amount of adhesive than narrow web applications. By eliminating the adhesive drying oven, one may double production from 400-500 feet per minute to 800-1000 feet per minute of film. Low energy costs are also yielded. A gravure coating method facilitates putting a heavier coating weight down to obtain satisfactory bonding, thus requiring a large oven to dry the solvent or water from the adhesive. The methodology taught in U.S. Pat. Nos. 6,464,813 B 1 and 6,491,783 B2 eliminated the need for this oven.

The improved adhesives described herein may be advantageously used in a four or five roll coating system, even at a high rate of speed, from 500 feet per minute to as much as 1,500 feet per minute because the improved adhesives of the present invention are highly resistant to misting due to their low viscosity, even at high coating speeds.

Any ink commonly used in flexible packaging is suitable for use with the adhesive of this invention. Inks derived from primary based materials such as polyurethane, acrylic, nitrocellulose, polyester, vinyl etc. are well suited for use with the adhesives herein described. The ink pigment systems vary widely as well depending on the requirements but are acceptable for use with these adhesives.

The adhesives described in this invention can be used with any film used in film lamination for food packaging. Although there are an infinite variety of film types, applications and manufacturers, the adhesives herein described are suitable for use with them. Films such as but not limited to polyethylene high density, low density, linear low density, metallocene and containing various amounts of ethylene vinyl acetate (EVA) for better sealing properties are suitable. Also suitable for use with the adhesives of this invention are the films of the following types:

Polyethylene plain or metallized

Polyester plain or metallized

Polyproplyene plain or metallized

Nylon plain or metallized

Aluminum foil

Paper in some special cases

Vinyl PVC

Surlyn

The polyacrylate/polymethacrylate esters are very fast reacting with the curing agent compared to the glycidyl ether resin and diluents. This fast reaction the reacted material upon coating to tend to stay more on the surface of the printed ink rather than to penetrate. It is the penetration that causes the ink to bleed and causes one color to mix with another causing distortion in the printing. In addition, the adhesive penetrated into the ink, once cured, can cause splitting of the ink layers or removal of the ink from the substrate. This is recognized as weak bonds in the lamination. In the present invention, the adhesive has very little ink penetration allowing the adhesive to stay on the surface and adhering to it without distorting the ink. This results in improved bond strength in the lamination. The use of the acrylate esters also gives a more flexible adhesive with improved adhesion properties to many substrates. This is shown in the higher bond strength of the laminations. These improvements can be seen in the following examples comparing the epoxy amine systems against the improved formulas of the new invention using acrylate esters.

### EXAMPLE 1

### Prior Art

The adhesive is prepared by mixing together Part A and Part B in a 2:1 part by weight mix ratio.

Part A is prepared by simple mixing of the following ingredients:

34% by weight, Bisphenol A type epoxy resin

51% by weight, C₁₂—C₁₄ aliphatic glycidyl ether

13% by weight, Dipropylene glycol dibenzoate

1% by weight, silicone free surfactant

1% by weight, nonionic defoamer

Part B is prepared by simple mixing of the following ingredients:

79% by weight, Amine curing agent

20% by weight, Aliphatic amidoamine curing agent

0.5% by weight, silicone free surfactant

0.5% by weight, nonionic defoamer

### EXAMPLE 2

### Prior Art

The adhesive is prepared by mixing together 100 parts by weight Part A and 36 parts by weight Part B.

Part A is prepared by simple mixing of the following ingredients:

75% by weight, Bisphenol A type epoxy resin

25% by weight, C₁₂—C₁₄ aliphatic glycidyl ether

Part B is an amine/epoxy adduct prepared by heating 78.5 parts of amine curing agent to 150 degrees F. and slowly adding 21.5 parts by weight Bisphenol A type epoxy resin under agitation. The exotherm created will cause heat rise so no further heat source is required. The process is carried on for approximately 1 hour and then cooled to form the useable adduct.

### EXAMPLE 3

### An Example of the Present Invention

The adhesive is prepared by mixing together 100 parts by weight Part A and 62 parts by weight Part B.

Part A is prepared by simple mixing of the following ingredients:

60% by weight, Bisphenol A type epoxy resin

40% by weight, Trimethylolpropane triacrylate

Part B consists of:

100% by weight, Polyoxypropylenediamine

### EXAMPLE 4

### An Example of the Present Invention

The adhesive is prepared by mixing together 100 parts by weight Part A and 76 parts by weight Part B.

Part A is prepared by simple mixing of the following ingredients:

47% by weight, Bisphenol A type epoxy resin

26.5% by weight, Trimethylolpropane triacrylate

26.5% by weight, Tripropylene glycol diacrylate

Part B is an amine/epoxy adduct prepared by heating 80 parts of polyoxypropylenediamine to 150 degrees F. and slowly adding 20 parts by weight Bisphenol A type epoxy resin under agitation. The exotherm created will cause heat rise so no further heat source is required. The process is carried on for approximately 1 hour and then cooled to form the useable adduct.

### EXAMPLE 5

### An Example of the Present Invention

The adhesive is prepared by mixing together 100 parts by weight Part A and 78 parts by weight Part B.

Part A is prepared by simple mixing of the following ingredients:

51% by weight, Bisphenol A type epoxy resin

34% by weight, Trimethylolpropane triacrylate

15% by weight, Octyl/decyl acrylate

Part B consists of the same adduct described in example 4, Part B.

### EXAMPLE 6

### An Example of the Present Invention

The adhesive is prepared by mixing together 100 parts by weight Part A and 91 parts by weight Part B.

Part A is prepared by simple mixing of the following ingredients:

60% by weight, Bisphenol A type epoxy resin

40% by weight, Trimethylopropane triacrylate

Part B is prepared by simple mixing of the following ingredients:

50% by weight, Polyoxypropylenediamine

50% by weight, Polyoxypropylenediamine

### EXAMPLE 7

### An Example of the Present Invention

The adhesive is prepared by mixing together 100 parts by weight Part A and 53 parts by weight Part B

Part A is prepared by simple mixing of the following ingredients:

50 % by weight, Bisphenol F type epoxy resin

5% by weight, Trimethyolopropane triacrylate

45% by weight, Dipropylene glycol diacrylate

Part B consists of:

100% by weight, Bis-(3-aminopropyoxy)diethyl ether.

### EXAMPLE 8

### An Example of the Present Invention

The adhesive is prepared by mixing together 100 parts by weight Part A and 47 parts by weight Part B.

Part A is prepared by simple mixing of the following ingredients:

70% by weight, Bisphenol F type epoxy resin

30% by weight, Trimethylolpropane trimethacrylate

Part B consists of:

100% by weight, Bis-(3-aminopropyoxy)diethyl ether.

The first two examples show the existing technology while the other examples show the improvements in bond values with this invention. All samples were coated using a sample of adhesive deposited on to the first web and pulling the second web on top of the first web using a smooth rod with the highest pressure to achieve a coating weight as close to 1 # per 3000 square feet as possible. Samples were allowed to stand at room temperature for 6 days to allow the adhesive to cure and perform bond strength tests.

TABLE 1
BOND STRENGTH GRAMS/INCH

| | Example # | | | | | | | |
|---|---|---|---|---|---|---|---|---|
| | 1 | 2 | 3 | 4 | 5 | 6 | 7 | 8 |
| PET/PE | 400 | 125 | 760 | 500 | 675 | 300 | 260 | 575 |
| MetPET/PE | 225 | 25 | 275 | 325 | 300 | 200 | 175 | 275 |
| Print PET/PE | 425 | 125 | 550 | 700 | 500 | 500 | 300 | 350 |
| Print OPP/OPP | Dst* | 225 | Dst* | Dst* | Dst* | 400 | Dst* | Dst* |
| Al Foil/PE | 400 | 75 | 575 | 450 | 575 | 300 | 250 | 540 |
| Met OPP/OPP | 210 | 125 | 450 | 275 | 275 | 210 | 200 | 275 |

*Dst means that the film failed or tore before the adhesive failed.

It can be seen from the data above that the preferred adhesive is the epoxy with polyacrylate ester. It shows improved adhesion to plain and printed substrates along with useable pot life and the best bond strengths on both printed and unprinted substrates.

Of course, various changes, modifications and alterations in the teachings of the present invention may be contemplated by those skilled in the art without departing from the intended spirit and scope thereof.

As such, it is intended that the present invention only be limited by the terms of the following claims.

43. In combination, two flexible films laminated together by a 2 part flexible plastic film laminating solventless adhesive composition made up of parts A and B and having a viscosity of from 10 to 2000 cps at 25° C. wherein part A comprises a mixture of epoxy resin and a polyacrylate ester and part B comprises a polyoxyalkylenepolyamine, parts A and B being mixed together to form said composition, and said composition adhered to and being used to laminate said flexible plastic films together without causing ink on said films to bleed, run, smear or delaminate from said films, said films being selected from the group consisting of polyethylene, polyethylene with metallocene, polyethylene with ethylene vinyl acetate, polyester, polypropylene, nylon, aluminum foil, paper, polyvinyl chloride and ethylene/methacrylic acid metal-salt ionomer, said films being used to package one or more food products.

44. In combination, two flexible films laminated together by a 2 part flexible plastic film laminating solventless adhesive composition made up of parts A and B and having a viscosity of from 10 to 2000 cps at 25° C. wherein part A comprises a mixture of epoxy resin and a polymethacrylate ester and part B comprises a polyoxyalkylenepolyamine, parts A and B being mixed together to form said composition, and said composition adhered to and being used to laminate said flexible plastic films together without causing ink on said films to bleed, run, smear or delaminate from said films, said films being selected from the group consisting of polyethylene, polyethylene with metallocene, polyethylene with ethylene vinyl acetate, polyester, polypropylene, nylon, aluminum foil, paper, polyvinyl chloride and ethylene/methacrylic acid metal-salt ionomer, said films being used to package one or more food products.

45. The combination of claim 43, wherein the epoxy resin of part A is selected from the group consisting of an aliphatic, cycloaliphatic, polyalkoxy or aromatic, mono or polyglycidyl ether, or any combination thereof.

46. The combination of claim 43, wherein the epoxy resin of part A is a liquid epoxy resin based upon Bisphenol A or Bisphenol F which is capable of being mixed with a mono or polyglycidyl ether selected from the group consisting of aliphatic, cycloaliphatic, polyalkoxy or aromatic.

47. The combination of claim 43, wherein said epoxy resin of part A is a liquid epoxy resin based upon Bisphenol A or Bisphenol F.

48. The combination of claim 43, wherein the ester of part A comprises a single or multi-component mixture selected from the group consisting of mono, di, tri, tetra or penta, acrylate or methacrylate ester.

49. In combination, two flexible films laminated together by a 2 part flexible plastic film laminating solventless adhesive composition having a viscosity of from 10 to 2000 cps at 25° C. wherein part A is comprised of a mixture of epoxy resin and a polyacrylate ester and part B comprises a polyoxyalkylenepolyamine or a mixture of polyoxyalkylenepolyamine and an adduct obtained from a reaction of a polyoxyalkylenepolyamine and a mono or polyglycidyl ether, parts A and B being mixed together to form said composition, and said composition adhered to and being used to laminate together said flexible plastic films without causing ink on said films to bleed, run, smear or delaminate from said films, said films being selected from the group consisting of polyethylene, polyethylene with metallocene, polyethylene with ethylene vinyl acetate, polyester, polypropylene, nylon, aluminum foil, paper, polyvinyl chloride and ethylene/methacrylic acid metal-salt ionomer, said films being used to package one or more food products.

50. The combination of claim 49, wherein said epoxy resin of part A is selected from the group consisting of aliphatic, cycloaliphatic, polyalkoxy and aromatic mono or polyglycidyl ether, or any combination thereof.

51. The combination of claim 49, wherein said epoxy resin of part A comprises a liquid epoxy resin based upon Bisphenol A or Bisphenol F mixable with a glycidal ether selected from the group consisting of aliphatic, cycloaliphatic, polyalkoxy and aromatic mono or polyglycidyl ether.

52. The combination of claim 49, wherein said epoxy resin of part A comprises a liquid epoxy resin based upon Bisphenol A or Bisphenol F.

53. The combination of claim 49, wherein said polyacrylate ester of part A comprises a single or multi-component mixture selected from the group consisting of mono, di, tri, tetra and penta, acrylate and methacrylate esters.

54. The combination of claim 49, wherein said polyacrylate ester of part A comprises trimethylolpropane triacrylate.
